(19) United States
(12) Patent Application Publication
(10) Pub. No.: US 2007/0167171 A1
(43) Pub. Date: Jul. 19, 2007

(54) Determining the Location of a Device Having Two Communications Connections

(75) Inventor: Donald M. Bishop, Highlands Ranch, CO (US)

Correspondence Address: MEDIACELL LICENSING CORP, 820 WELCH AVE, KRAJEC PATENT OFFICES, LLC, BERTHOUD, CO, 80513, US

(73) Assignee: MediaCell Licensing Corp, Centennial, CO (US)

(21) Appl. No.: 11/618,584

(22) Filed: Dec. 29, 2006

Related U.S. Application Data
(60) Provisional application No. 60/755,397, filed on Dec. 30, 2005.

(51) Int. Cl. H04Q 7/20

(52) U.S. Cl. 455/456.1

(57) ABSTRACT

Wireless devices connected to a network backbone may be physically located by establishing communications between an unknown device and one or more known devices. Through distance estimation and/or directional estimation, the physical location of a network device may be determined by triangulation. In some instances, the new device may passively receive signals by which the device location may be determined, while in other instances, the device may transmit a signal that is received by other network devices.

### CROSS REFERENCE TO RELATED APPLICATIONS

This application claims priority to and benefit of U.S. Provisional Patent Application Ser. No. 60/755,397 filed 30 Dec. 2005 by Donald M. Bishop entitled “Determining the Location of a Device Having Two Communications Connections”, which is hereby incorporated by reference for all it discloses and teaches.

### BACKGROUND OF THE INVENTION

Wireless networks are becoming ubiquitous. A typical network may have multiple wireless transmitters that may be connected by a network backbone. The network backbone may connect a wireless access point to the Internet or a service provider of some sort. In many cases, the wireless access points may be positioned in close enough proximity that two neighboring access points may be able to communicate wirelessly, outside the normal network backbone channel.

The physical location of devices on a dispersed network such as a cable television plant is surprisingly difficult to determine. Although each device may be assigned a network address which is required for normal communications, the physical location of a device may be poorly documented. Through normal maintenance practices, various devices may be swapped for other devices and the documentation of where a particular device with a specific network address may be quite difficult to determine.

### SUMMARY OF THE INVENTION

Wireless devices connected to a network backbone may be physically located by establishing communications between an unknown device and one or more known devices. Through distance estimation and/or directional estimation, the physical location of a network device may be determined by triangulation. In some instances, the new device may passively receive signals by which the device location may be determined, while in other instances, the device may transmit a signal that is received by other network devices.

### BRIEF DESCRIPTION OF THE DRAWINGS

In the drawings,

FIG. 1 is a diagrammatic illustration of an embodiment showing a network capable of determining the position of a device by triangulation.

FIG. 2 is a diagrammatic illustration of an embodiment showing a network with sectored antenna systems for triangulation.

FIG. 3 is a diagrammatic illustration of an embodiment showing a device having a network connection and a wireless connection.

FIG. 4 is a flowchart illustration of an embodiment showing a method for passively receiving location signals by a device.

FIG. 5 is a flowchart illustration of an embodiment showing a method for actively transmitting location signals by a device.

### DETAILED DESCRIPTION OF THE INVENTION

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the subject matter as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

Throughout this specification, the term “comprising” shall be synonymous with “including,” “containing,” or “characterized by,” is inclusive or open-ended and does not exclude additional, unrecited elements or method steps. “Comprising” is a term of art which means that the named elements are essential, but other elements may be added and still form a construct within the scope of the statement. “Comprising” leaves open for the inclusion of unspecified ingredients even in major amounts.

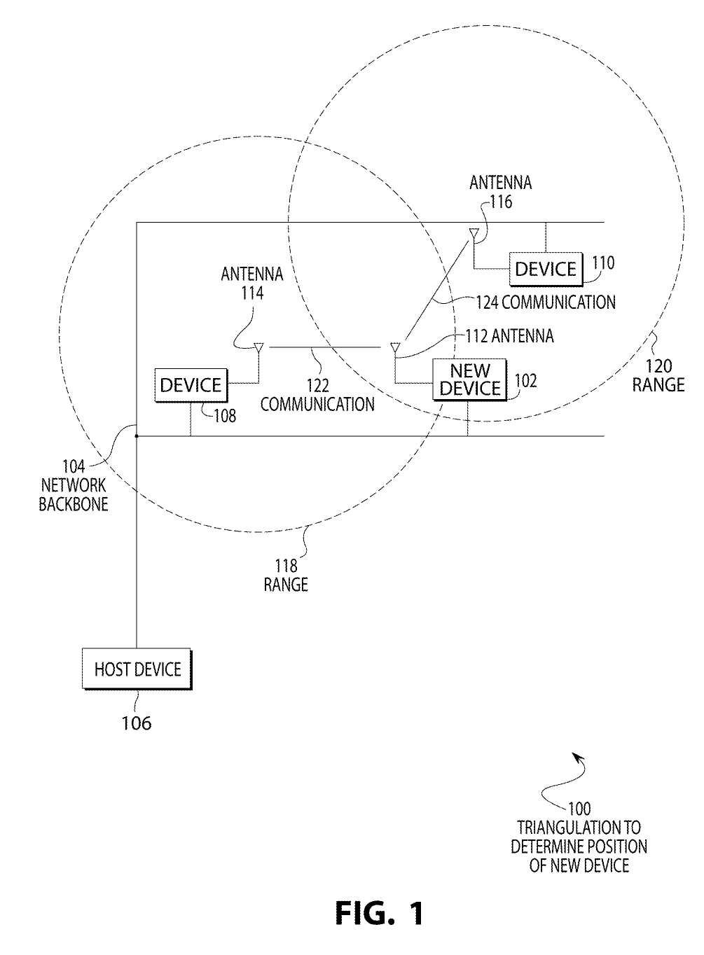

FIG. 1 illustrates an embodiment 100 showing a network where triangulation is used to determine the physical location of a device. The device 102 is connected to a network backbone 104 that has a host device 106. Additional devices 108 and 110 are also attached to the network 104. The device 102 has an antenna 112 for wireless communication. Similarly, devices 108 and 110 have antennas 114 and 116, with effective ranges 118 and 120, respectively. In order to determine the approximate physical location of device 102, communication path 122 is established between device 102 and device 108, and communication path 124 is established between device 102 and device 110. By knowing that the device 102 is in both of the ranges 118 and 120, the location of the device 102 may be determined with at least a coarse degree of accuracy.

The embodiment 100 illustrates a network that may be used for delivering wireless access for various communications systems. The various devices 102, 108, and 110 may be wireless access points, for example, that enable subscribers to connect to the internet, telephony, or other communications services. The host device 106 may provide a link to a wide area network in some embodiments.

In the embodiment 100, each device 102, 108, and 110 has two relevant modes of communication: across the network backbone 104 and wirelessly. In normal operation, the devices may communicate upstream to the host device 106 and to each other through the network backbone 104, and may communicate downstream to wireless devices through the various radios and antennas.

In order to determine the physical location of device 102, communication is established between the device 102 and neighboring wireless devices through the wireless channel. When communication is established between neighboring devices, at least a coarse physical location can be determined by assuming that the device 102 is at least within the intersection of the range 118 and range 120. Other techniques may be used to refine the accuracy of the physical location, such as making distance and direction measurements of the communication paths 122 and 124.

In many cases, even a coarse physical location can be very useful. For example, in many networks, the location of each transceiver may be well known when the network is first established. During the course of maintenance, a device may be swapped for another device, and the new device may begin to function properly. The locations of all the device mounting points may be very discrete and well known, but the unique identification numbers of the devices may not correlate with the physical location, especially after several service actions have occurred. In such a case, a coarse location may be sufficient to determine which location has been serviced. In other embodiments, a more accurate location of a device may be required.

The embodiment 100 uses the known physical location of devices 108 and 110 to determine the approximate physical location of the device 102. Once communication paths 122 and 124 are established, the location of the device 102 may be determined by triangulation. The host device 106, devices 108 or 110, or device 102 may process the information to determine the physical location of device 102. In some embodiments, only one device with a known location may be used, while in other embodiments, three or more devices with known locations may be used to more accurately determine the physical location of a particular device.

The network backbone 104 may be any type of useful communications mechanism. In some embodiments, the network backbone 104 may be a hybrid fiber coax network commonly used for cable television distribution systems. In other embodiments, the network backbone 104 may be a twisted pair network commonly used for digital subscriber line (DSL) service. Any type of network backbone may be used, including hardwired and wireless communications backbone.

In some embodiments, the network backbone 104 may be a wireless network. Such embodiments include those where the network backbone 104 is a different frequency, protocol, or mechanism than the wireless communication used to connect with downstream subscribers. Such embodiments also include those where the network backbone 104 is the same wireless communication frequency, protocol, and standard used to communication with downstream subscribers.

The network may operate using any type of communications mechanisms, such as Ethernet, TCP/IP, or any other communications protocol.

The device 102 may operate in an active mode or passive mode when establishing the physical location of device 102. In an active mode, the device 102 may broadcast a signal that is received by neighboring devices 108 and 110. In such a mode, the devices 108 and 110 may be set in a special mode to receive such a broadcast signal or may recognize the broadcast signal and handle the signal appropriately in the course of normal operations. Upon receiving such a broadcast signal, the devices 108 and 110 may establish two way communications with the device 102 or may use data from the received broadcast signal to perform any triangulation calculations.

The device 102 may be a passive mode wherein the various devices attached to the network, with the exception of device 102, may send broadcast messages that may be received by device 102. Device 102 may establish two way communications with devices from which it receives messages, or data from the signals received by device 102 may be sufficient to perform any triangulation calculations.

The communications 122 and 124 may be used to estimate distance between the various devices. If a broadcast signal was transmitted at a known power level, the receiving device may use the received power level, multipath, or other measured parameters to estimate the distance from the transmitting device to the receiving device.

In another embodiment, the length of time for a transmission to travel from one device to another may be used to calculate separation distance. In one of such embodiments, one device may perform a loop-back where a received message is instantly returned to the other, sending device. The sending device may measure the time difference between sending and receiving the signal to determine the distance between the two devices with considerable accuracy. The length of time for a signal to travel in a one-way direction from one device to another may also be measured directly in some circumstances.

The more accurately the distance between two devices may be measured, the more accurately the position of an unknown device may be determined. In some embodiments, the location of a device may be determined with a fraction of an inch resolution, while in other embodiments, the location of a device may only be resolved to a mile or more, especially where little if any distance measurement is attempted.

In some embodiments, the direction of a communication path may be determined when directional antennas are used. In such embodiments, the reception of a signal in a particular sector of a sectored antenna system may aid in triangulating the position of an unknown device, especially when only one neighboring device is present.

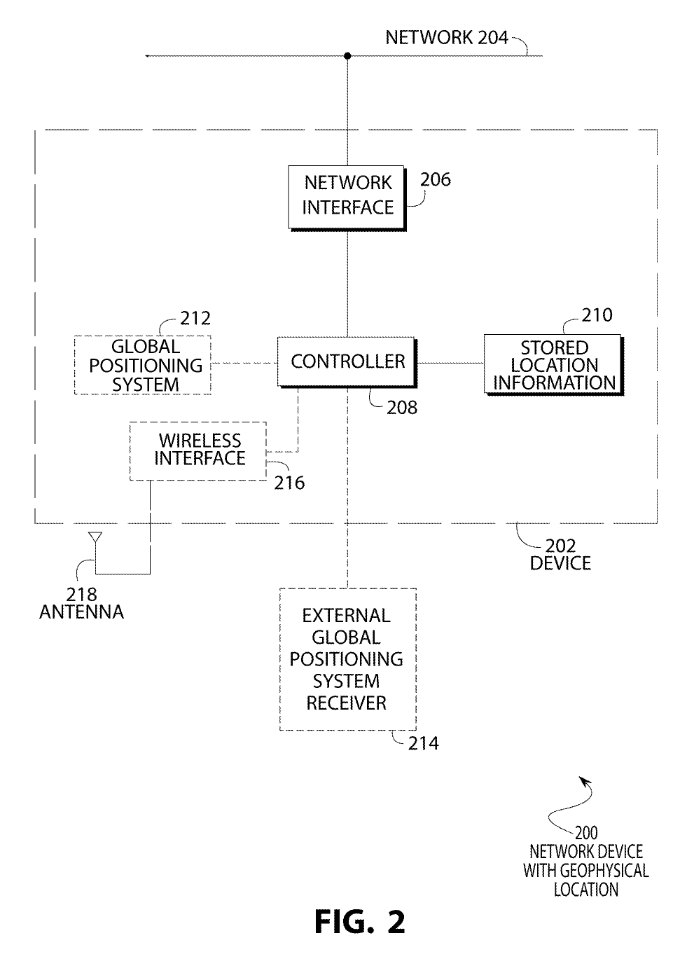

FIG. 2 illustrates an embodiment 200 showing position determination using sectored antennas. The new device 202 is attached to the network 204 that has a host device 206, and devices 208 and 210. The device 202 has a sectored antenna 212 that can selectively transmit and receive signals in eight discrete sectors. Similarly, device 208 has a sectored antenna system 214. Device 210 may have a unidirectional antenna 216.

The device 202 may receive and/or transmit in the sector 218 with the device 208 and may receive and/or transmit in the sector 222 with the device 210. Similarly, device 208 may receive and/or transmit using the sector 220. By using a directional transmission and reception system, the source of a transmission or direction of a transmission may be narrowed to a specific sector, enabling a smaller set of possible locations to be used for triangulation calculations.

The position of device 202 may be determined through triangulation by establishing at least one way communication between device 202 and device 208 in sectors 218 and 220. Having established communication in the sectors, the location of device 202 may lie anywhere within the sector 220 as far away as the outer transmission range of the device 208. If the distance between the two devices 202 and 208 may be determined, the possible locations of device 202 may be fairly restricted to an arc lying within the sector 220 at the measured distance. If communication may be established between device 202 and device 210 in the sector 222, and the distance between devices 202 and 210 is determined, a precise location of device 202 can be calculated.

The sectored antenna systems 212 and 214 may be any type of antenna and transceiver system whereby signals can be isolated into sectors. In some embodiments, devices 202 and 208 may contain eight separate radio transceivers, each with a separate directional antenna oriented into a specific sector. Other embodiments may use other techniques to separate radio transmission and reception operations into sectors.

When one or more of the devices used in triangulation has a sectored antenna system, the potential locations for the unknown device is further limited and the accuracy of the triangulation calculation may thereby be enhanced.

The sectored antenna system may be used by a transmitting device, a receiving device, or by both the receiving and transmitting devices. In some embodiments, a combination of devices transmitting unidirectionally and in a sectored fashion may be used.

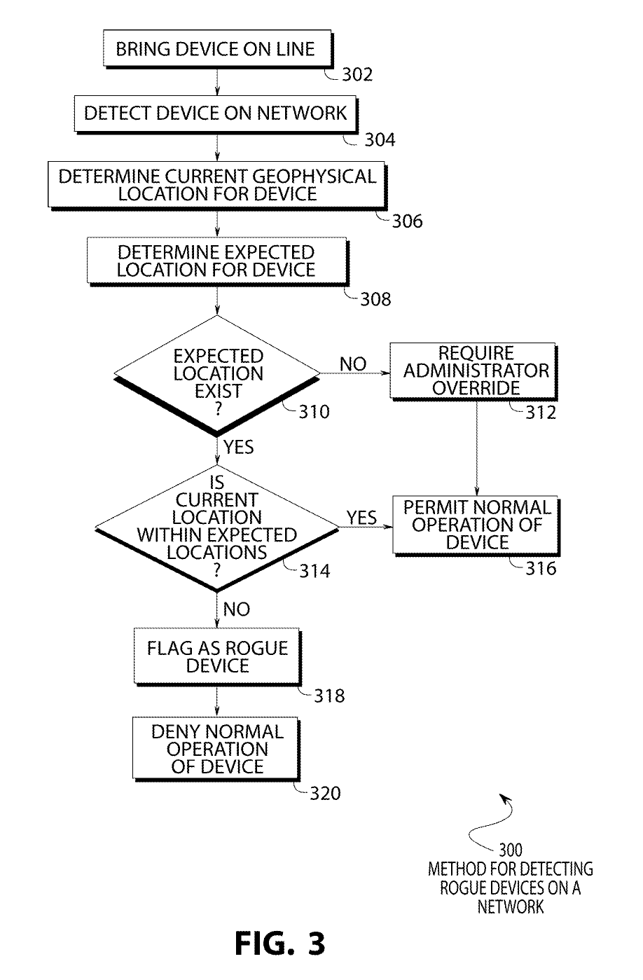

FIG. 3 illustrates an embodiment 300 of a device attached to a network. The device 302 is connected to a network 304 through a network interface 306. A controller 308 may communicate and coordinate messages between the network interface 306 and a wireless interface 310, which has an antenna 312.

The device 302 may be any type of interface between a first network 304 and a wireless device. In some embodiments, the first network 304 may be a hardwired network, using twisted pair, coaxial cable, or any other type of physical layer connection. In other embodiments, the network 304 may be a wireless network or have a wireless connection between the device 302 and another device on the network 304.

The controller 308 may respond to commands from devices attached to the network 304 or through the wireless interface 310. For example, the controller 308 may provide authentication and access control to various wireless devices. In another example, the controller 308 may be configured and operated by a remote device located upstream on the network 304. In many cases, the controller 308 may process signals between devices on the network 304 and wireless devices communicating with the wireless interface 310.

In some embodiments, the controller 308 may be capable of determining a position location for the device 302 by receiving signals from neighboring devices and triangulating a location based on such signals. In some embodiments, the controller 308 may establish two-way communication between the device 302 and a neighboring device for the purposes of triangulating the position of device 302 with respect to the position of any neighboring devices. In such embodiments, the controller 308 may determine a distance and direction to a neighboring device as part of triangulating a position.

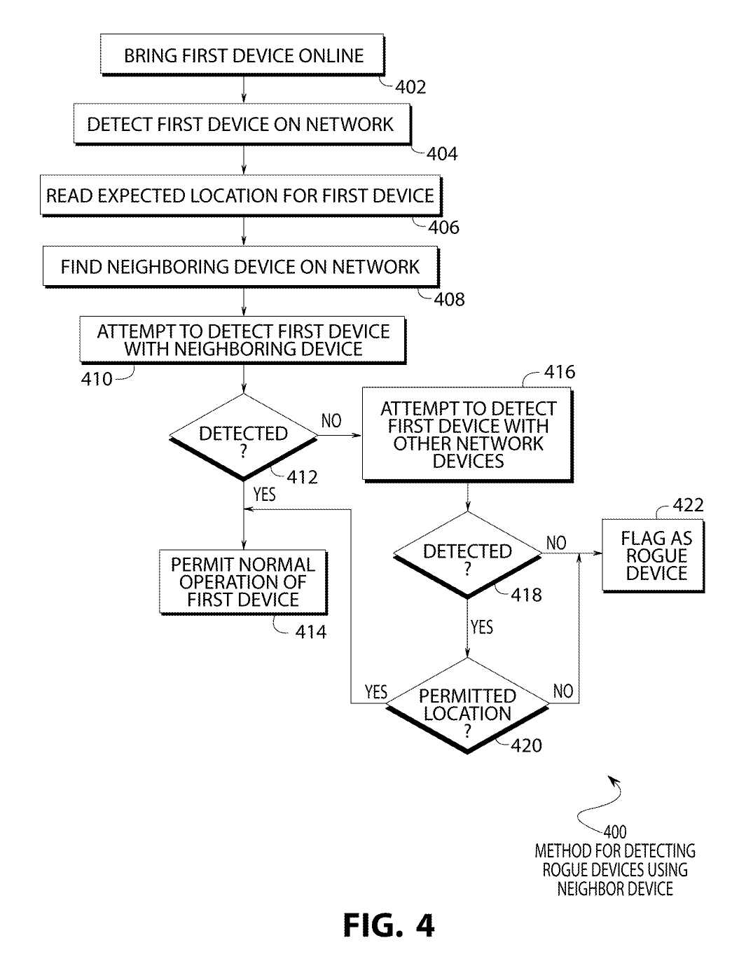

FIG. 4 is a flowchart illustration of an embodiment 400 of a method for triangulating position of a network-attached device. The method begins in block 402. The device is attached to the network in block 404. Other devices on the network transmit locating signals in block 406, those signals are received in block 408 by the device. For each device transmitting a locating signal in block 410, an approximate distance is established in block 412 and an approximate direction is established in block 414. The location of the device is determined by triangulation in block 416 and the method ends in block 418.

The method for establishing an approximate distance in block 412 comprises measuring the power level of the received signal as an estimate of distance in block 420. Some embodiments may establish two way communication in block 422 and measure the time for one-way communication in block 424. Other embodiments may establish a loop-back configuration for one of the devices in block 426 and transmit a signal and measure the round-trip transmission time in block 428 to calculate the distance between a device with a known location and a device with an unknown location.

The method for establishing an approximate distance in block 414 comprises determining from which direction a signal is received in block 430 and/or determining to which direction a signal was sent. Either or both methods may be used to narrow the potential locations of an unknown device when triangulation is performed in block 416.

The method 400 uses the device with an unknown location as a passive device, receiving messages from other devices and determining a position based on what is received. In some embodiments, two-way communication may be established to more accurately measure distance or direction to a device with a known location.

In some embodiments, the devices with known locations may be connected to the same network as the device with unknown location. In such embodiments, a host device or other device on the network may instruct some or all of the devices on the network to broadcast a signal that is received by the device with unknown location. The broadcasting devices may transmit the location signal in unison, in sequence, or randomly from time to time, depending on the embodiment. In some situations, the wireless devices may transmit certain beacon signals as a standard feature of a wireless standard. Such standard beacon signals may be used for triangulation without requiring a network device to send a command to the devices to do so.

In some situations, the devices that transmit signals received by the device with unknown location may be devices not connected to the network backbone. For example, a television or radio station beacon, signals from a cellular telephone tower, radio location signals used for aircraft navigation, or any other fixed transmission device with a known location may be used by the device with unknown location to estimate the position of the device. In some embodiments, satellite signals may also be used to triangulate a location for a device.

When multiple devices are located in block 408, each incoming signal may be separately evaluated in block 410. The greater the number of incoming signals, the more accurate the results will be from the triangulation calculation. In some cases, the number of signals may result in conflicting or redundant location information. In such cases, the position may be averaged between all of the conflicting information, or once a conclusive location is determined, some data may be ignored.

One measure of distance may be power level in block 420. When a signal is transmitted at a known power level, the power level of the signal at the receiving device may be used to calculate the distance between the receiving device and the transmitting device.

In another measure of distance, the one-way transmission time may be measured in block 424. If two devices have a precisely synchronized clock or reference, the travel time of a signal from one device to another can be readily measured.

In yet another measure of distance, one of the devices may be configured as a loop-back device. In such a configuration, the device may receive a message then transmit the same message or a reply message very quickly. In some situations, a known delay may occur between the reception and transmission of a message, while in other situations, the reply message may be sent nearly instantaneously. The sending device may be able to measure the elapsed time from sending the original message to receiving the response and thereby calculate the distance between the two devices with some degree of precision. Other methods may also be used to determine the distance from one device to another.

The direction from one device to another may also be used in some triangulation calculations to determine a location of one of the devices. One technique may include determining the direction from which a signal is received in block 430. Such a technique may be possible when the receiving device has the ability to discriminate the direction of an incoming signal. A receiving device with sectored antennas, diversity antennas, or some other passive or active design may be able to determine the direction of a received signal. Similarly, some devices may be able to control the direction of an outgoing signal in block 432 and that direction may also be used in triangulation calculations.

In some embodiments, the resolution of a signal direction may be very coarse, such as being able to isolate a signal to a specific sector or merely a general direction. Even when the direction information is coarse, the information may be useful in determining general location of a device.

The triangulation calculations of block 416 may comprise any method by which the location of the device with unknown location may be determined from the information collected by receiving signals from neighboring devices. In many cases, the known location of each device in communication with the device with unknown location may be positioned on a map. For each device transmitting a signal, an arc from the transmitting device may be drawn at the calculated distance to the receiving device. If no distance is known, an arc may be drawn at the outer limits of the range of the transmitting device. When a signal direction is known, the arcs may be limited to the sector in which the signal was known to have traveled. The intersection of the arcs or areas may contain the location of the receiving device.

In some embodiments, the triangulation calculation may be performed manually using writing instruments on a map. In other embodiments, the triangulation calculations may be performed using a computer, either with or without the means to display a map.

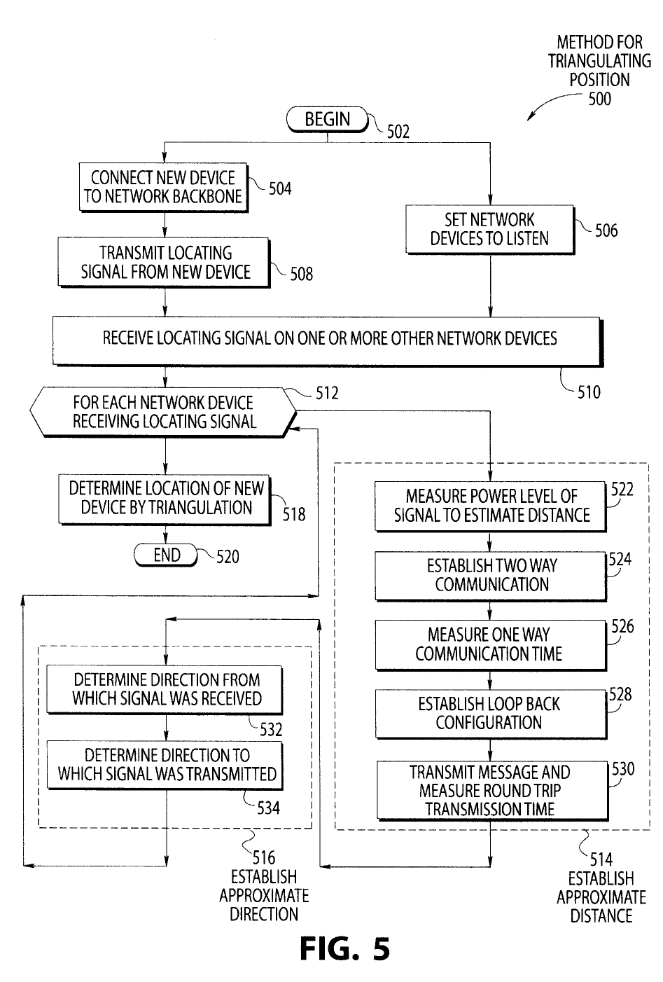

FIG. 5 is a flowchart illustration of an embodiment 500 showing a method for triangulating position. The method begins in block 502. A device is connected to a network backbone in block 504 and other devices on the network are configured to receive a locating signal in block 506. A locating signal is transmitted by the device in block 508, and received by one or more other network devices in block 510. For each of the receiving network devices in block 512, the approximate distance between the devices is determined in block 514 and the approximate direction to the devices is determined in block 516. The location of the device is determined by triangulation in block 518 and the method ends in block 520.

The distance between the devices determined in block 514 may comprise measuring power level of the received signal in block 522, establishing two-way communications in block 524 and measuring one-way communication time in block 526. Another method for determining distance may include establishing a loop back configuration for one of the devices in block 528 and measuring a round trip message transmission time in block 530.

The direction between the communicating devices determined in block 516 may comprise determining from which direction a signal was received in block 532 and/or determining which direction a signal was transmitted. Various mechanisms and antenna configurations may be used in determining the direction a signal was transmitted or received.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of determining a location of a first device comprising:
establishing communications with said first device on a first communications network;
establishing communications with said first device on a second communications network with a second device, said second communications network being a wireless communications network, said second device being connected to said first communications network and having a first known location; and
determining an approximate physical location for said first device by the method comprising:
sending a signal between said first device and said second device; and
establishing that said first device is within a range of said second device.

2. The method of claim 1 wherein said signal is sent from said first device to said second device.

3. The method of claim 1 wherein said signal is sent from said second device to said first device.

4. The method of claim 1 further comprising:
detecting said signal by a third device, said third device having a second known location and being connected to said communications network.

5. The method of claim 1 further comprising:
determining a distance from said first device to said second device.

6. The method of claim 5 further comprising:
measuring a transmission time from said first device to said second device and from said second device to said first device.

7. The method of claim 1 wherein said determine a location is performed by said first device.

8. A first device comprising:
a connection to a first communications network;
a connection to a second communications network, said second communications network being a wireless network; and
a controller adapted to perform a method comprising:
establishing communications with said first device on said first communications network;
establishing communications with said first device on said second communications network with a second device, said second device being connected to said first communications network and having a first known location; and
determining an approximate physical location for said first device by the method comprising sending a signal between said first device and said second device, and establishing that said first device is within a range of said second device.

9. The device of claim 8 wherein said method further comprises:
determining a direction from said first device to said second device.

10. The device of claim 8 further comprising at least one directional antenna.

11. The device of claim 10 further comprising a plurality of directional antennas arranged in sectors.

12. The device of claim 9 wherein said second device comprises at least one directional antenna.

13. The device of claim 12 wherein said second device further comprises a plurality of directional antennas arranged in sectors.

14. The device of claim 12 wherein said first communications network comprises a hybrid fiber-coax network.

15. The device of claim 12 wherein said first communications network comprises an Ethernet network.

16. The device of claim 12 wherein said first communications network comprises a fiber optic connection.

17. The device of claim 12 wherein said first communications network comprises a radio link.

18. A network comprising:
a first communications channel;
a second communications channel being a wireless communications channel;
a first device connected to said first communications channel and said second communications channel;
a second device connected to said first communications channel and said second communications channel, said second device having a first known location;
wherein said network is adapted to determine the approximate location for said first device by a method comprising:
establishing communications with said first device on said first communications network;
establishing communications with said first device on said second communications channel with a second device, said second device being connected to said first communications network and having a first known location; and
determining an approximate physical location for said first device by the method comprising sending a signal between said first device and said second device, and establishing that said first device is within a range of said second device.

19. The network of claim 18 wherein said signal is sent from said first device to said second device.

20. The network of claim 18 wherein said signal is sent from said second device to said first device.
